(19) United States
(12) Patent Application Publication
(10) Pub. No.: US 2006/0293991 A1
(43) Pub. Date: Dec. 28, 2006

(54) Method and arrangement for playing back media contents

(75) Inventors: Stefan Jenzowsky, Munchen (DE); Christoph Hielscher, Munchen (DE); Axel Scheuer, Munchen (DE); Harald Schweickhardt, Munchen (DE); Rudolf Steizi, Dachau (DE)

Correspondence Address: JUNGMAN INC.;THOMAS C. HARRIS, PRESIDENT, 405 PERSIMMON LANE, ROSWELL, GA, 30076, US

(73) Assignee: Siemens Aktiengesellschaft

(21) Appl. No.: 11/472,854

(22) Filed: Jun. 22, 2006

(30) Foreign Application Priority Data
Jun. 22, 2005 (EP) 05013488.1

(51) Int. Cl. G06Q 40/00

(52) U.S. Cl. 705/35; 705/38

(57) ABSTRACT

An improved method and an improved arrangement for video on demand is provided. It is provided according to the invention that a VoD user can select media contents from the multiplicity (“library”) of media contents offered by a VoD provider and add said contents to a virtual loan resource assigned to him or, as the case may be, his terminal device (104). The user can view contents contained in this virtual loan resource as often as desired; charge tickets for the subsequent charging for the use are generated at regular intervals, for example for each day or every 24 hours, for as long as the media content to be charged for resides in the virtual loan resource of the user. The user can terminate the loan by means of a “virtual” return of the borrowed media content; the media content is removed from his virtual loan resource and is then no longer available to the user. The virtual loan resource is formed by means of pointers to the media contents borrowed in each case.

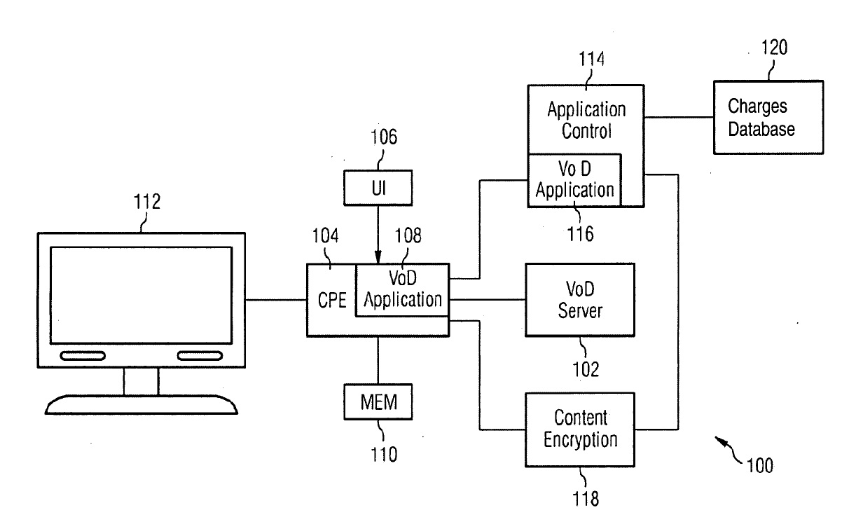

### CROSS REFERENCE TO RELATED APPLICATIONS

This application claims priority of European application No. 05013488.1 EP filed Jun. 22, 2005, which is incorporated by reference herein in its entirety.

### FIELD OF INVENTION

The present invention relates to a method and an arrangement for playing back media contents. In particular the present invention provides an improved method and an improved arrangement for video on demand.

### BACKGROUND OF INVENTION

Classical television, initially broadcast by antenna and unable to be influenced by the user, has shaped the consumer behavior of users over decades. In the meantime, with the availability of broadband connections, services have emerged which allow the user substantially greater flexibility in the consumption of video contents.

A service of this kind is known as video on demand, described for example in U.S. Pat. No. 5,442,390. In different variations of video on demand the user is allowed, often for a separate charge, either to view video content, for example a particular film, on a single occasion, or to view video content a number of times within a specific period of time. Solutions exist here in which central servers transmit the contents in realtime or near-realtime to a terminal device of the user, and solutions in which the video contents are initially stored in the terminal device of the user, mostly protected by digital rights management, and then played back.

### SUMMARY OF INVENTION

However, in contrast to the borrowing of video content stored on data media, with video on demand the user cannot extend the loan of the video content simply by keeping it for longer: after the agreed use (e.g. one-time viewing or any desired use for 24 hours) the user loses access to the video content and must re-order it. In the process, however, he also loses all the bookmarks and other markers (e.g. pause/resume markers) which he created during the first period of use.

From the perspective of the provider of video on demand (VoD) it is desirable to create an offering which also provides a borrowing and return process for VoD contents in order to be able to obtain increased revenue from the charges levied for lending days additionally used by the user.

An object of the present invention is therefore to create an improved method and an improved arrangement for video on demand which simplify the use of video-on-demand content for the user.

This object is achieved by an arrangement and a method according to the independent claims. Preferred embodiments are set forth in the dependent claims.

It is provided according to the invention that a VoD user can select media contents from the multiplicity (“library”) of media contents offered by a VoD provider and add them to a virtual loan resource assigned to him or, as the case may be, to his terminal device. The user can view contents included in said virtual loan resource as often as desired; charge tickets for the subsequent charging for use are generated at regular intervals, for example for each day or every 24 hours, for as long as the media content to be charged for resides in the user's virtual loan resource. The user can terminate the loan by “virtual” return of the loaned media content; the media content is removed from his virtual loan resource and is then no longer available to the user. The virtual loan resource is formed by pointers to the media contents borrowed in each case.

An advantage of the invention is to be seen in the fact that by means of the invention it is made possible for the user to enjoy a VoD film with more leisure than is possible with conventional VoD solutions in which the user has to reserve the film again after 24 hours or even for each viewing. By means of the invention a user can view part of the film on a particular day and the rest of the film two or three days later without, for example, losing the pause marker or bookmarks in the meantime and without having to go through the—sometimes complex and time-consuming—borrowing and order procedure again.

A further advantage of the invention is to be seen in the fact that it is made possible for a VoD provider to achieve higher revenues because the user makes use of the convenience gained as a result of the invention and keeps films longer than necessary in his virtual loan resource in order, say, to be able to view particular scenes (e.g. identified by means of bookmarks) a number of times over. The provider can also use the invention in order to levy higher charges for late return following expiry of a provider-defined standard loan period (e.g. 2 days) or alternatively to levy lower charges according to whether or not the provider attaches importance to prompt virtual return of the film (because, for example, the provider only has a limited number of VoD licenses for a particular media content). This can be controlled via the value of the generated charge tickets, which value increases or decreases accordingly with the loan period. In addition the provider can provide that a content which was contained in the virtual loan resource of a user for a relatively long period of time (e.g. 20 days) and was charged for accordingly is deemed to have been purchased by said user. The user can then, for example, be sent a data medium with a recording of the content or be granted the option of producing a recording of the content.

### BRIEF DESCRIPTION OF THE DRAWING

Preferred exemplary embodiments of the present invention are explained in more detail below with reference to a drawing. The FIGURE shows an arrangement of an exemplary arrangement of VoD system in accordance to the present invention.

### BRIEF DESCRIPTION OF THE DRAWINGS

The single FIGURE shows an arrangement 100 having an exemplary VoD system comprising a VoD server 102, a controller or Application Control 114 and an optional encryption controller or Content Encryption 118. The VoD server 102 is used for storing VoD contents, for example films. In an alternative exemplary embodiment other media contents may also be stored on the VoD server, such as, for example, music albums, to which the mechanisms described below mainly with reference to video contents can be applied in an analogous manner.

The controller 114 is used for controlling the retrieval of content by terminal devices 104. The controller can be connected to a charges database 120 in which charge tickets generated by the controller 114 and other charge-relevant control information are received and linked to user accounts for immediate or subsequent invoicing. The controller controls the encryption controller 118, if present, and optionally also the VoD server 102 (not shown).

The controller 114, the VoD server 102, the encryption controller 118 and the charges database 120 are arranged centrally and are located in the control area of a VoD provider and can serve a plurality of terminal devices 104.

Shown by way of example is a terminal device 104 which is served by the controller 114, VoD server 102, encryption controller 118 and charges database 120. The terminal device 104 can be equipped with or coupled to local memory 110 which can be embodied, for example, as a conventional hard disk and/or as flash memory and/or as RAM. Special embodiments such as micro hard disk drives present in the flash memory card format are also conceivable, of course. In this case flash memory has the advantage that it is possible to store the data independently of the availability of a supply voltage and at the same time particularly quiet terminal devices 104 are made possible, since flash memory has no rotating or other mechanical parts. In this case the memory 110 can be permanently coupled to the terminal device 104 or be designed as a replaceable component.

The terminal device or CPE 104 can be a set-top box which is connected to an image playback device 112. Alternatively the terminal device 104 can be integrated in the image playback device 112. The image playback device 112 can be a conventional television. Alternatively it can be a monitor that has no TV tuner of its own. The terminal device 104 has a user interface 106 which serves the user for example for selecting device settings and for browsing and managing his virtual loan resource. Said user interface can be implemented, as is usual in the set-top boxes sector, in such a way that the user makes inputs via a remote control and receives outputs displayed via the image playback device 112.

If the user has decided to make use of the VoD offering of the VoD provider, he can select a media content, e.g. a film, from the VoD offering by means of the user interface. During the selection process the price to be paid per borrowing day is displayed to the user together with the information that this price is to be paid for as long as the film resides in the user's loan resource. This is acknowledged by the user, and a terminal-device-side part 108 of a distributed VoD application 108, 116 signals the loan of the requested media content to a provider-side part 116 of the distributed VoD application. The controller 114 checks the authorization of the user to be able to retrieve said media content, provided this did not take place already during the selection process, and if the result is positive sends an address to the terminal-device-side part 108 of the distributed VoD application. This address identifies the media content on the VoD server 102, and the retrieval of the media content by the user terminal device 104 can begin.

In an exemplary embodiment the media content is stored in encrypted form on the VoD server. The terminal-device-side part 108 of the distributed VoD application requests from the encryption controller 118 a key for decrypting the data stream received from the VoD server 102. The encryption controller 118 inquires of the controller 114 whether a corresponding authorization of the terminal device 104 is present and, if this is the case, provides a suitable key for the terminal device 104.

For as long as the media content is included in the virtual loan resource of the user it can be provided that the user plays back the media content in any desired manner. In particular it can be provided that the user plays back the content as often as desired and with any desired interruptions, sets bookmarks, etc. While a media content resides in the user's virtual loan resource, charge tickets are generated at regular intervals and sent to the charges database 120. For example, a timer can be provided which times out every n hours (e.g. every n=24 hours), whereby a charge ticket is generated upon its timing out and the timer is reinitialized. Alternatively a process is started at regular intervals, which process checks all the virtual loan resources and generates corresponding charge tickets for the pointers to contents contained therein, for example by evaluating the age of a loan timestamp of the pointer. It can be provided that an alert is displayed to the user when he switches on his terminal device if a media content has already been resident in his virtual loan resource for more than z days (e.g. z=4 days).

In order to terminate the loan, the user selects a media content from the current loan resource on his terminal device 104 by means of the user interface 106 and selects a corresponding return option offered by the user interface. The distributed VoD application 108, 116 signals the return process and the key(s) made available to the user for decrypting the corresponding media content is (are) made invalid. A final charge ticket can be generated which specifies the entire borrowing period, for example to enable the VoD provider to provide a complete record as evidence of the use of the media content.

In order to simplify the handling of the invention, various automatic functions can be provided in embodiments of the invention.

It can be provided, for example, that a loan applies initially only for a basic period of time (e.g. 24 or 48 hours) and the content is included in the loan resource and further charged for only if the user has not yet terminated the active use of the content after the basic period of time has expired. Active use, in this context, can include: viewing the film; the retaining of pause markers after pausing the playback of the film; the retaining of set bookmarks, etc.

It can further be provided that a film is automatically regarded as returned if the last active use was more than m hours ago (e.g. m=24 hours), i.e. the film was last viewed m hours ago, and all markers (pause, bookmarks) have been removed.

In addition or alternatively the provider can provide that a content which was included for a relatively long period (e.g. 20 days) in the virtual loan resource of a user and charged for accordingly is regarded as having been purchased by this user. The user can then, for example, be sent a data medium with a recording of the content or be granted the option of creating a recording of the content. For this purpose it can be displayed to the user in the view of his virtual loan resource how many borrowing days remain until the loan is considered a purchase.

1.-10. (canceled)

11. An arrangement for a Video on Demand (VoD) system to allow a playback of a downloadable media content, comprising:
a controller;
a VoD server for storing a plurality of digitally encoded media contents;
a terminal device providing a first selection for selecting a media content and providing a second selection for removing the media content, the media content selected from the plurality of media contents, the selection transmitted to the controller,
a database that receives a charge ticket;
a VoD application distributed between the controller and the terminal device, the application administers a virtual loan resource related to the terminal device, the application comprising:
a pointer controller that adds a pointer to the media content in the virtual loan resource in response to the media content selection from the terminal device, and removes the pointer in response to remove selection from the terminal device,
a ticket generator that periodically generates a charge ticket for the media content during a time the virtual loan resource includes the pointer;
wherein the media content is released for display on the terminal device by the controller when the virtual loan resource includes the pointer for the media content, and
wherein the server serves a plurality of terminal devices.

12. The arrangement according to claim 11, wherein the ticket generator generates a ticket every 24 hours.

13. The arrangement according to claim 11, wherein the application further comprises a display that displays the virtual loan resource.

14. The arrangement according to claim 13, wherein the application evaluates user commands received at the terminal device and generates a marker to the media content in the virtual loan resource in response to a bookmark command used during the playback or in response to an interruption of the playback.

15. The arrangement according to claim 11, wherein the application evaluates user commands received at the terminal device and generates a marker to the media content in the virtual loan resource in response to a bookmark command used during the playback or in response to an interruption of the playback.

16. The arrangement according to claim 15, wherein the application removes the pointer for the terminal device in response to a deletion of all markers relating to the media content.

17. The arrangement according to claim 16, wherein the ticket generator generates a ticket every 24 hours.

18. A method for releasing media content on a Video on Demand (VoD) server for playback on a terminal device, comprising:
adding a pointer to the media content in a virtual loan resource in response to a first selection on the terminal device, the media content selected from a plurality of media contents stored on the VoD server;
releasing for display on the terminal device via a controller if the virtual loan resource includes a pointer for the media content;
providing a VoD application distributed between the controller and the terminal device, the application comprising:
administering of the virtual loan resource,
periodically generating a charge ticket if the virtual loan resource includes the pointer, and
removing the pointer from the virtual loan resource in response to a second selection on the terminal device.

19. The method according to claim 18, wherein the charge ticket is generated every 24 hours during a time frame that the virtual loan resource includes the pointer.

20. The method according to claim 18, further comprising displaying the virtual loan resource for a selected terminal device.

21. The method according to claim 20, wherein the application further comprises:
evaluating a user command received at the terminal device,
generating a bookmark maker in response to the setting of a bookmark during the playback of the media content, and
generating an interrupt maker in response to an interruption of the playback.

22. The method according to claim 21, further comprising deleting the pointer to the media content from the virtual loan resource in response to the deletion of all markers relating to the media content.

23. The method according to claim 18, wherein the application further comprises:
evaluating a user command received at the terminal device,
generating a bookmark maker in response to the setting of a bookmark during the playback of the media content, and
generating an interrupt maker in response to an interruption of the playback.

24. The method according to claim 23, further comprising deleting the pointer to the media content from the virtual loan resource in response to the deletion of all markers relating to the media content.

25. The method according to claim 24, wherein the charge ticket is generated every 24 hours during a time frame that the virtual loan resource includes the pointer.

26. A method for releasing media content on a Video on Demand (VoD) server for playback on a terminal device, comprising:
providing a user interface to the terminal device;
providing a controller having an first interface to the terminal device and a second interface to a charges database;
providing an VoD application distributed between the terminal device and the controller;
retrieving the media content from the server in response to a first selection by a user of via the user interface, the media content selected from a plurality of media contents stored on the VoD server;
adding the retrieved media content to a virtual loan resource;
releasing the media content for display on the terminal device via the controller if the virtual loan resource includes the media content;
generating a late charge by the application if the virtual loan resource includes the media content;
sending information pertaining to the late charge to the charges database; and
removing the media content from the virtual loan resource by the application, the remove in response to a second selection by the user via the user interface.

27. The method according to claim 18, wherein the late charge is generated after a standard loan period.

28. The method according to claim 19, wherein the late charge is generated periodically while the virtual loan resource includes media content.

29. The method according to claim 18, further comprising displaying a loan duration of the media content.

30. The method according to claim 18, wherein a marker is added to the virtual loan resource to indicate a bookmark or a pause of the playback for the media content, and the media content is automatically removed from the virtual loan resource after a period of time of viewing the media content if all the markers have been removed for the media content.
